(19) United States
(12) Patent Application Publication
(10) Pub. No.: US 2013/0185126 A1
(43) Pub. Date: Jul. 18, 2013

(54) ONLINE PROMOTIONAL SYSTEMS AND METHOD

(71) Applicant: Discount On International Pty Ltd, Keysborough (AU)

(72) Inventor: Benjamin Stefanescu, Keysborough (AU)

(73) Assignee: DISCOUNT ON INTERNATIONAL PTY LTD, Keysborough (AU)

(21) Appl. No.: 13/743,437

(22) Filed: Jan. 17, 2013

(30) Foreign Application Priority Data
Jan. 17, 2012 (AU) 2012900179

(51) Int. Cl. G06Q 30/02

(52) U.S. Cl. CPC G06Q 30/0213
USPC 705/14.13; 705/14.15

(57) ABSTRACT

In one preferred form there is provided a computer implemented coupon system 100 for offering coupons 102 in connection with products and services 104. The system 100 includes a sale facility 106 adapted to allow individuals to purchase the coupons 102 online. The coupons 102 each provide a reduction in price associated with a specific product or service. The system 102 includes a communications facility for displaying, to the individuals, coupon information 110 associated with the coupons.

### FIELD OF THE INVENTION

The present invention relates to online promotional systems and methods. In a number of preferred forms computer implemented coupon systems and methods are provided.

### BACKGROUND TO THE INVENTION

The Internet has been widely used in order to advertise goods and services. In particular, the Internet has been used to advertise such goods and services at a discount or reduced rate in order to entice customers into stores. This may then lead to further purchases of other items, thereby overriding the initial discount.

However, it is difficult where a customer, in search of a particular item, wishes to determine the lowest price attainable and must sort through a vast number of webpages and identify various relevant search terms to locate relevant search results within a geographic area.

Further, such discounts can be offered or displayed for a limited time. Therefore, many users are forced to pay full price for an item or service as they were unaware that a discount was available. For purchasers, this can lead to dissatisfaction and a lack of customer loyalty. The business can suffer loss of potential profits from the discount or purchases of additional items/services.

In addition, the number of individuals who intend to rely on a discount can be unclear. This can be difficult for services such as hotels where ignorance of the number of people using a discount can lead to double or over booking and not having sufficient rooms to cover the demand.

This also leads to situations where the purchaser is not able to use the discount. Where the user prepaid for the discounted amount to use the coupon, the purchaser would have suffered a monetary loss.

Therefore, the purchaser is at a risk of such monetary loss where the business fails to recognise such a coupon or for practical reasons, the user is unable to attend the place of business to claim the discount.

The purchaser is at further risk of monetary loss where fraudulent retailers request prepayment of discounts with no intention of providing such a discount or honoring the voucher.

A further disadvantage is that such discounts, if not confiscated by the retailer after single use, can be exploited amongst the same customer a number of times or amongst multiple purchasers by sharing the single discount. This results in unintended and unplanned loses by the retailer.

Further disadvantages arise where the webpage operator increases offer amounts to include commission costs, thereby reducing the discount value to the purchaser and reducing its appeal to the purchaser and the retailer to access and use the website. For retailers, the lack of clear guidance as to the proportion of the money owed to each causes confusion as to what sum of the payment amount is to be transferred to the retailer and is to remain with the operator.

Whilst a background to the invention has been provided, it is to be recognised that any discussion in the present specification is intended to explain the context of the present invention. It is not to be taken as an admission that the material discussed formed part of the prior art base or relevant general knowledge in any particular country or region.

### SUMMARY OF THE INVENTION

According to a first aspect of preferred embodiments herein described there is provided a computer implemented coupon system for offering coupons in connection with products and services comprising: a sale facility adapted to allow individuals to purchase coupons online, the coupons each providing a reduction in price associated with a specific product or service; and a communications facility for displaying, to the individuals, coupon information associated with the coupons.

Preferably the communications facility includes a coupon tracker; the coupon tracker being adapted to provide coupon providers with a clear indication of the number of individuals who have purchased coupons and, as a result of the purchases, are likely to intend to use them.

Preferably the system includes a points facility adapted to allow the individuals to purchase points, the sale facility being adapted to allow the individuals to purchase the coupons using the points.

Preferably the majority of the coupons are able to be purchased for a single point.

Preferably a single unit of the points, excluding any bulk discounts, equates to the most convenient unit of real currency of a jurisdiction determined by the system.

Preferably the most convenient unit of real currency is one Australian dollar when the determined jurisdiction is Australia.

Preferably the most convenient unit of real currency is one US dollar when the determined jurisdiction is the United States of America.

Preferably the most convenient using of currency is one EURO when the determined jurisdiction is a member of the European Union.

Preferably the computer implemented coupon system includes an assurance facility adapted to provide an individual with a refund when a coupon is not honoured.

Preferably the computer implemented coupon system includes an assurance facility adapted to provide an individual with refund when the products or services associated with a coupon are not received by the individual, after the coupon has been redeemed.

Preferably the computer implemented coupon system includes a determination facility for automatically generating coupon data based on a regular retail price and an effective discounted price.

Preferably the determination facility is preconfigured to automatically generate the coupon data based on a coupon purchase price of a single point.

Preferably the computer implemented coupon system includes a location facility for allowing each individual to specify a location, the sale facility being adapted to show coupons associated with the location.

According to a second aspect of preferred embodiments herein described there is provided a computer implemented method of providing coupons for products and services comprising: providing coupons online for purchase by individuals, the coupons each providing a reduction in price associated with a specific product or service; and displaying, to the individuals, coupon information associated with the coupons.

Preferably the computer implemented method includes providing a tracking facility adapted to provide coupon providers with a clear indication of the number of individuals who have purchased the coupons and, as a result of the purchases, are likely to be intending to use them.

Preferably the computer implemented method includes providing a points facility adapted to allow the individuals to purchase points, so as to allow the individuals to purchase the coupons online using the points.

Preferably the computer implemented method includes ensuring that the majority of the coupons are able to be purchased for a single point.

Preferably the computer implemented method as claimed in claim 14 wherein a single point, excluding any bulk discounts, equates to the most convenient unit of real currency of a jurisdiction determined by the system.

Preferably the most convenient unit or real currency is one Australian dollar when the determined jurisdiction is Australia.

Preferably the computer implemented method includes providing a refund facility and ensuring that individuals are provided with a refund when a coupon is not honoured.

Preferably the computer implemented method includes providing a refund facility and ensuring that individuals are provided with a refund when the products or services associated with a coupon are not received by the individual, after the coupon has been redeemed.

Preferably the computer implemented method includes ensuring that the value of the coupon to the individual, when redeeming the coupon, is more than the value of the sale price of the coupon.

Preferably the computer implemented method includes automatically generating coupon data based on a regular retail price and an effective discounted price.

Preferably the computer implemented method includes preconfiguring the method to automatically generate the coupon data based on a coupon purchase price of a single unit of points.

In another aspect there may be provided a method of obtaining a product, including the steps of:
a) providing a communication means for display of an effective offer for the product by an offeror;
b) providing an access means to use the displayed effective offer upon purchaser of an access point;
c) providing a coupon to the offer value to the user to open acceptance of the displayed offer and payment to the value of the offer less the value of the purchase of the access point;
d) allowing redemption of the offer and collection of the product by the offeror upon the offeror confirming validity of the coupon.

In another aspect there is provided a system for obtaining a product, the system comprising:
an operators product register containing one or more computers for recording details of the product, the details including actual value of the product, point value of the opportunity of placing a purchase request and the offeror's discount, the register using the said details to determine an offer value being the price payable by the purchaser directly to the offeror;
a determinator for determining a costing for obtaining a right to claim the product from the offeror, the costing comprising the offer value amount payable in money directly to the offeror following processing of a purchase request, the amount of the point value payable in refundable credits issued to a purchaser from a website operator, a point value providing the value of the opportunity of placing a purchase request in one or more computers, the point value account including details of a purchaser, details of point values issued to the purchaser and details of point values used by the purchaser;
a display means accessible by the purchaser, the display means displaying details of the product including cost and availability, the display means further comprising a request entry means whereby the purchaser enters the purchase request for the selected product;
and processing means for processing the purchaser's request, the processing means reserving the requested product; and
payment means, the payment means receiving payment of the required monies to the value of the offer value directly to the offeror to obtain the product.

In one preferred form, the processing of the purchaser's request provides an active voucher that has a unique client identification number that is machine readable and active for a predetermined period of time or upon occurrence of a predetermined event. The active voucher becomes deactivated upon the offeror's recognition of the identification number and the payment means receiving payment of the required monies. The active voucher further becomes deactivated upon expiry of the predetermined period of time.

The client identification number may be a barcode.

The payment means may be received at the offeror's place of business or online.

In a number of embodiments, systems and methods provides the determination of an offer value, according to the equation:

O=(A−D)−P

wherein:
O=Offer value
A=Actual value of product
D=Offeror's discount
P=Point value

The display means may provide for the limited display of the product according to a timer.

Further preferred aspects of the invention may provide for a method of refunding the refundable credits of the point value back to the purchaser, comprising the steps of:
providing a virtual point value credit register where the operator provides for a predetermined number and value of refundable credits in the register capable of purchase by a purchaser to allow the purchaser access to an effective offer, the register tracking and monitoring the number and value of credits purchased;
determining the point value to each of the products to determine the point values required by a purchaser to access the effective offer and place the purchase request;
allocating the determined number of points to the effective offer;
providing a communication means for the display of the effective offer to a prospective purchaser;
obtaining access to the effective offer upon the purchasers presentation of the credits to the number and value of the point value determined and allocated to the effective offer by the determinator, the effective offer having the unique active barcode defining the status of the effective offer, the effective offer capable of being deactivated upon recognition of the barcode of the effective offer by offeror;
accepting the active status of the effective offer and confirming the status of the effective offer by the purchaser;
refunding the number and value of points determined and allocated to the effective offer, the points being recorded on the register and capable of use for a second effective offer.

A preferred aspect of the invention may comprise a communication means having an offer comprising:
a first status as a displayed offer, the displayed offer presented to a prospective purchaser by a display means;
a second status as an effective offer, the effective offer having an active client identification number that is machine readable to render the effective offer deactivated upon an offerror's recognition of the identification number;
an access means determining and allocating the displayed offer a number and value of points required to access the displayed offer;
a register recording, tracking and storing the purchaser's points;
wherein, the offer is converted from the first status to the second status upon the recognition by the communication means that the register stores points of number and value equal to the number and value of points allocated to the displayed offer.

The displayed offer is preferably displayed for a predetermined period of time according to a timer.

In one form, the effective offer is active for a predetermined period of time or upon occurrence of a predetermined event. The effective offer is in the form of an active voucher which becomes deactivated upon the offeror's recognition of the identification number and the payment means receiving payment of the required monies. The active voucher further becomes deactivated upon expiry of the predetermined period of time.

The client identification number may be a barcode.

The displayed offer may illustrate the determination of an offer value, according to the equation:

O=(A−D)−P

wherein:
O=Offer value
A=Actual value of product
D=Offeror's discount
P=Point value

In yet another aspect there is provided a communication system for the purchase of a product, comprising:
a communication means having a simultaneous line of communication between:
   an offeror providing a displayed offer of a product, communicated to the purchaser by a display means, the offeror determining discounted offer to be communication to the purchaser;
   a purchaser viewing the displayed offer, purchasing points to convert the displayed offer to an active effective offer;
   an operator determining the number and value of points to each displayed offer and determining the number and value points available for purchase by the purchaser;
a determinator for determining a costing for determining the point value payable to have the opportunity of placing a purchase request in one or more computers.

In yet another aspect there is provided a system for obtaining a product, the system comprising:
an operators product register containing one or more computers for recording details of the product, the details including actual value of the product, point value of the opportunity of placing a purchase request and the offeror's discount, the register using the said details to determine an offer value being the price payable by the purchaser directly to the offeror;
a determinator for determining a costing for obtaining a right to claim the product from the offeror;
a display means accessible by the purchaser, the display means displaying details of the product including cost and availability, the display means further comprising a request entry means whereby the purchaser enters the purchase request for the selected product;
and processing means for processing the purchaser's request, the processing means reserving the requested product, and
payment means, the payment means receiving payment of the required monies to the value of the offer value directly to the offeror to obtain the product.

It is to be recognised that other forms of the present invention will be apparent from the drawings and description of preferred embodiments, and the claims provided below.

Herein, the term ‘product’ is used as a matter of convenience to encompass both goods and services that may be purchased in person or online.

### BRIEF DESCRIPTION OF THE DRAWINGS

A number of preferred embodiments of the invention will now be described by way of example only, with reference to the accompanying drawings, in which:

FIG. 1 provides a diagrammatic view of Example A and Example B of the display of the effective offer in accordance with one embodiment of the invention;

FIG. 2 provides a visual representation of an effective offer in accordance with one embodiment of the invention;

FIG. 3 provides a first table identify the point's module and a second table providing the statistical assessment undertaken by the determinator.

FIG. 4 provides a visual representation of the point purchaser scheme as part of the point's module;

FIG. 5 provides a schematic of the lines of communication and the components of each element, in accordance with one embodiment of the invention;

FIG. 6 provides a flow chart illustrating the purchaser's use of the communication means;

FIG. 7 provides a flow chart of the webpage operation during access of the webpage according to FIG. 6;

FIG. 8 provides a flow chart of communication between the webpage operator and the retailer;

FIG. 9 provides a flow chart of the communication between the webpage operator and the purchaser;

FIG. 10 provides a process plan of the input and output of the communication means;

FIG. 11 provides a schematic of the operational features of the webpage;

FIG. 12 provides a schematic of the infrastructure of the coupon module in accordance with one embodiment of the invention;

FIG. 13 provides a flow chart of determination of the value of the coupon;

FIG. 14 provides a schematic of a system in accordance with another embodiment of the invention;

FIGS. 15 to 19 provide further illustrations of the system shown in FIG. 14;

FIG. 20 provides an illustrative representation of a method according to a preferred embodiment of the present invention.

FIGS. 21 to 25 provide an illustration of a method according to a further preferred embodiment of the present invention; and

FIG. 26 provides a schematic diagram of a computer system providing preferred embodiments described herein.

### DESCRIPTION OF PREFERRED EMBODIMENTS OF THE INVENTION

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

In one of the preferred embodiments described, there is provided a system/method for obtaining an offeror's product. The embodiment operates on an internet or software platform. On the internet platform, the embodiment operates on an operator controlled website having a communication means that operates between each party and each component of the embodiment.

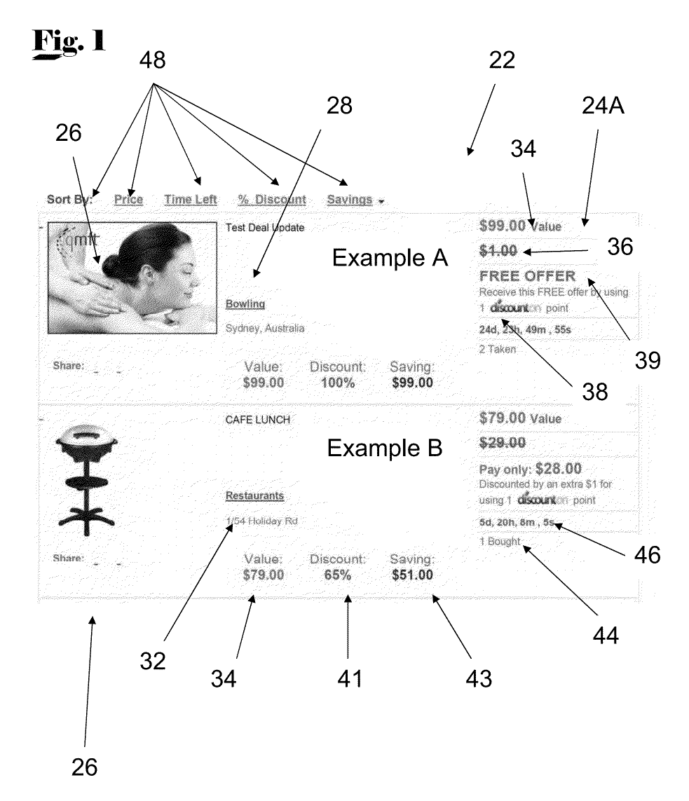

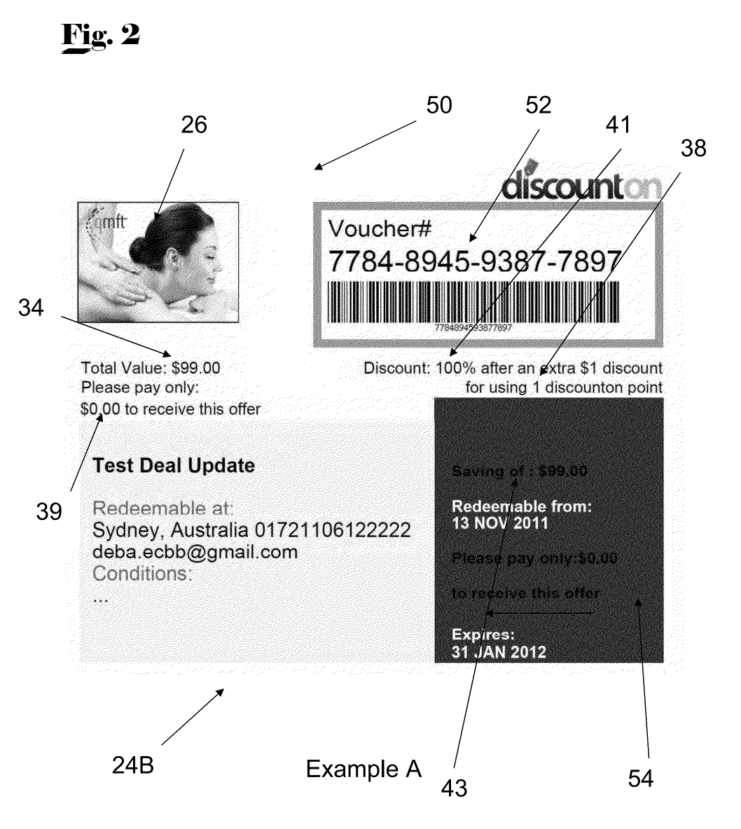

The communication means comprises an operator's product register that is illustrated to the user on a display means 22, in accordance with FIG. 1, to provide a listing of one or more offeror's products in the form of displayed offers 24A. The display means illustrates to the purchaser the displayed offer 24A which become an effective offer 24B (see FIG. 2) on purchase. The display means can be a webpage of the website. The operator's product register therefore comprises a listing of one or more offeror's products.

The displayed offer, in accordance with Example A of FIG. 1 provides a visual representation 26 of the product which is the subject of the offer, a product title 28 of the offer, details such as location 32 and further identifies the offer value 39. The offer value 39 is the value of the coupon the purchaser is to pay upon redemption of the offer.

The embodiment provides a determinator to determine the offer value 39 of the displayed offer. FIG. 1 illustrates the actual value 34 of the product which is the full price of the product, without a discount. It can be based on the recommend retail price of the product. The actual value 34 can be determined by the retailer or the operator. However, in one embodiment, the communication means can have an assessment module which is able to determine the actual value of the product by reference to prices tracked on particular websites, catalogues etc.

The retailer further provides the offeror's discount 36. This is the amount the offeror is willing to discount the product to. Therefore, based on the actual value, the offeror determines the discount, taking into consideration that there will also be a further reduction of the point value. In example A, the offeror's discount is the discounted price of $1.00 on a product having an actual value of $99.00. In Example B, the offeror's discount is the reduced price of $29.00 on a product having an actual value of $79.

The operator provides a point value 38 to each displayed offer which acts as a further discount that is proportional to the value determined by a determinator of allowing a purchaser access to the effective offer 24B, or allowing a purchaser to place a purchaser request. This is a consideration by the offeror when determining their discount. This value can be calculated based on the actual value or a consistent value set by the operator. In both example A and B, the value is a consistent value of 1 point. The 1 point equates to a value of $1. This one point, having a value of $1.00, is deducted and offset from the offeror's discount 36. In Example A, this reduces the offeror's discount of $1.00 to $0. In example B, this further reduces the offeror's discount of $29 to an offer value 39 of $28.

The embodiment then provides for the calculation of the discount variation 41 and total discount sum 43. The discount variation is a calculation of the percentage difference between the actual value 34 and the offer value 39. Therefore, in Example A where the reduction is from an actual value of $99 to $0, the discount variation 41 is 100%. The total discount sum 43 is the calculation of the total saving and is the actual value 34 minus the offer value. Therefore as in Example A, the actual value 34 is $99 and the offer value 39 is $0, the total discount sum 43 is $99.

A tracker 44 identifies and monitors the number of coupons purchased, that is, the number of coupons transferred from a displayed offer 24A to an effective offer 24B.

A timer 46 further identifies to the purchaser the time remaining in which the displayed offer 24A can be processed by a processing means and transferred to an effective offer 24B. Once the timer has ended, the displayed offer can be removed from the operators product register.

The different values calculated by the determinator can be further calculated according to the following equation:

O=(A−D)−P

wherein:
O=Offer value
A=Actual value of product
D=Offeror's discount
P=Point value

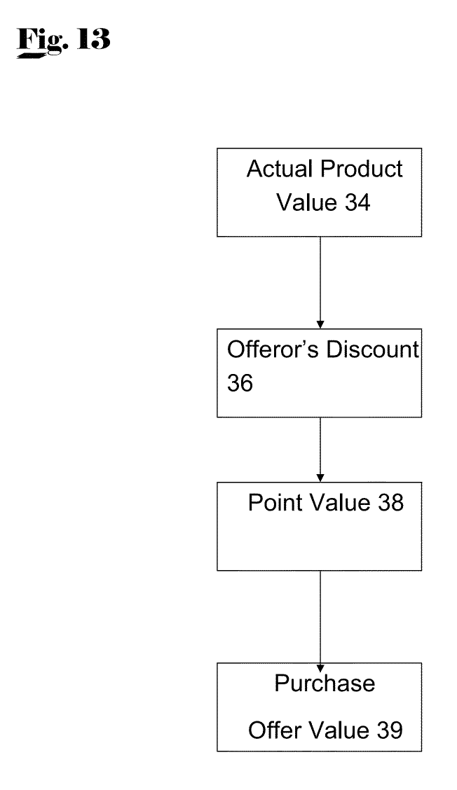

FIG. 13, further provides the steps undertaken by the determinator in calculating the different offer value.

The displayed offers can be visually presented to the purchaser in a number of manners as the website provides a number of selective criteria 48. The selective criteria in Example 1, comprises of Price, Time Left, % Discount and Savings. The ‘Price’ selective criteria allows for the purchasers listings to be categorised in accordance to the actual value 34. The ‘Time Left’ selective criteria allows the listings to be categorised in accordance to the timer 46, the ‘% Discount’ selective criteria allows the listings to be categorised in accordance with the discount variation 41 and the ‘Savings’ selective criteria allows the listings to be categorised in accordance with the total discount sum 43.

FIG. 2 provides an example representation of an effective offer 24B in the form of a redeemable voucher. The redeemable voucher can be in a printable format allowing the user to print a copy upon its generation.

The voucher can be pre-generated by the offeror to provide a known number of predetermined vouchers having predetermined client identification numbers, which can be in the form of a unique and active barcode 52. Alternatively, the voucher can be generated upon the conversion can of the displayed offer 24A to an effective offer 24B.

The voucher provides for the visual representation 26 of the offeror's product, the actual value 34, the offer value 39, the discount variation 41, the point value 38 and total discount sum 43. The voucher can further include conditions 54. The conditions can set out limitations of the offer, dates the offer is valid from or valid to, expiry date, location and times redeemable.

The voucher is then taken to the retailer and processed through a payment means. The payment means processes the purchasers request at the point of sale and receives monies to the value of the offer value 39. The payment means can be physical, at the retailer's place of business, or online. To obtain the product, the voucher, having an active machine readable barcode, is processed by the operating systems of the operator by scanning or entering the barcode as required, or allowing the purchaser to enter the barcode online as required. Upon processing, the payment means identifies the offer value 39. Monies are then provided by the purchaser directly to the retailer according to the offer value 39.

The active barcode is deactivated upon occurrence of a predetermined event. The payment means, where the retailer recognises the barcode by, deactivates the barcode and does not allow further use and prevents exploitation of the single voucher. The purchaser's profile page (discussed below) is automatically updated with details of which coupons have been purchased and deactivated allowing a purchaser to keep track of coupons purchased and used. Further, the active barcode can be deactivated where the voucher has not been redeemed within the predetermined time period.

The voucher specifies the offer value 39. This is the value that is outstanding and to be paid directly to the retailer at the point of purchase. Therefore, the operator retains the monetary value associated with the point value 38 and the offeror obtains the cost of the offer value 39 thereby providing a clear and efficient method of transferring costs to the relevant parties.

The operator and/or the retailer can determine the circumstances in which a refund of the voucher can occur. For example, a refund can occur where the retailer is fraudulent or where the retailer is no longer able to provide the service. Alternatively, it can be provided where the purchaser has made an error in purchase or has had a change of mind. In such a situation, the refund module of the communication means is activated.

In the refund module, the purchaser requests refund of the point value 38 as, when a display offer has been transferred to an effective offer, this is the amount that has been expended to date by the purchaser. To reclaim the point value 38, which can then be used against other display offers, the purchaser is to enter the barcode 52 on the voucher into the website. The operator and/or the retailer can confirm whether the barcode is active or deactivated. Such confirmation can be done manually, by the retailer checking their financial records or can be done automatically as the processing of the payment means at the point of sale at the retailer provides a feedback link back to the communication means to list the voucher as deactivated and to update the purchasers profile page to illustrate that the voucher has been used.

Upon confirmation, the effective offer 24B is cancelled and the point value 38 is returned back to the purchaser. The cancellation prevents use of the active barcode following refund. The purchaser and retailer are notified of the cancellation.

If the confirmation process identifies that the barcode has been deactivated, the request for refund is rejected and the purchaser is notified accordingly.

Each purchaser is to sign up and become a member to the webpage. In signing, each member creates a personal profile page detailing their personal and contact details. The personal profile page also provides for a virtual point value credit register and a voucher register.

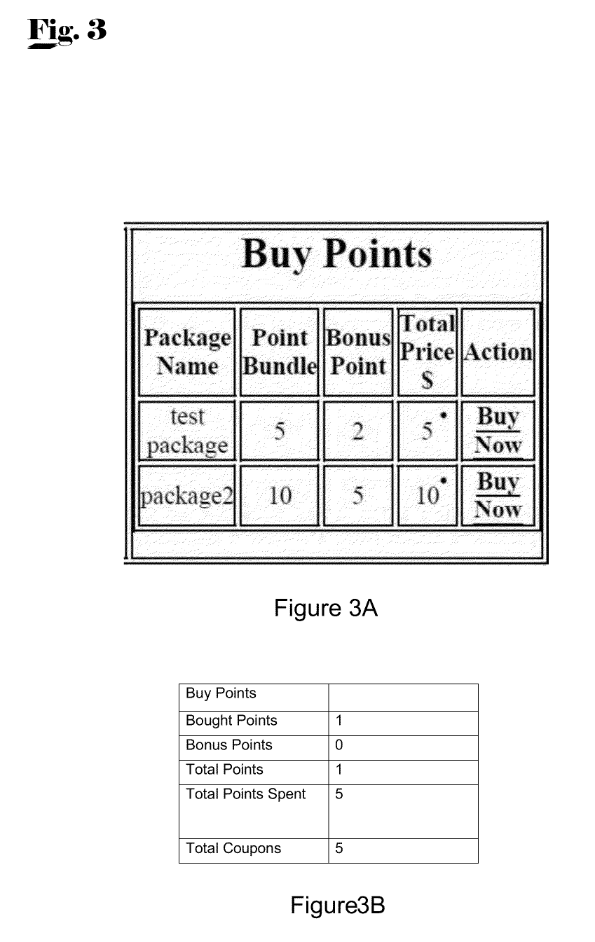

Examples of the credit register are shown in FIG. 3. The credit register shows the number of refundable credits the purchaser has, the numbers brought and the numbers spent. The credits are used to meet the value of the point value required to have access to the displayed offer.

The purchaser can purchase the point value 38 in bundles depending on the currency and monetary value of the point. In FIG. 3A, the points are valued at $1 per point. Therefore, for $5 a purchaser can purchase 5 points. The system also provides for bonus points to further entice purchasing of points.

The embodiment further collates relevant statistical data of the point value 38 and the purchaser's behaviour. For example, FIG. 3B identifies the number of credit points bought, the bonus points obtained, total points. It also identifies the total points spent and the total number of coupons obtained. Such assessment can highlight particular purchasers for different levels of membership or additional discounts.

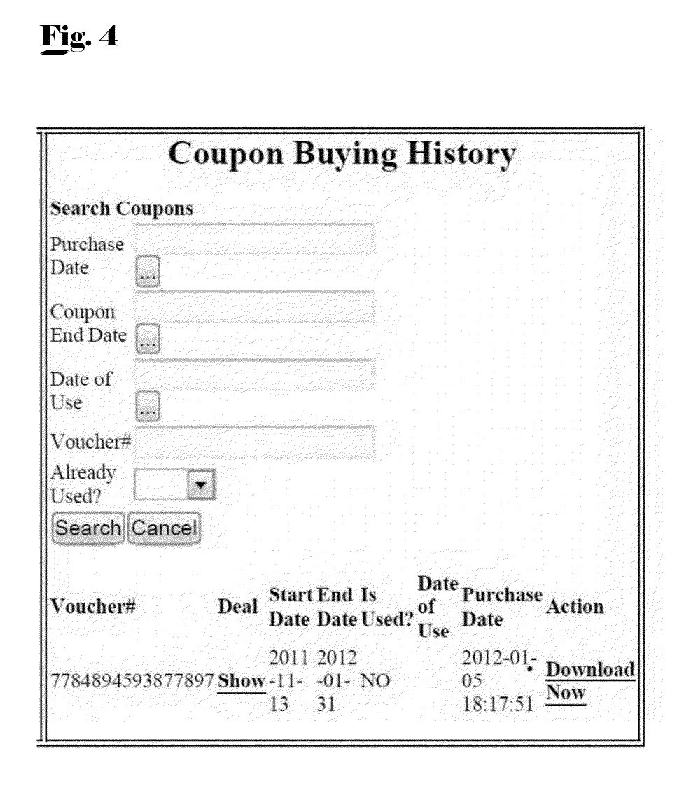

The purchasers profile page further provides for a voucher register, shown by example in FIG. 4. Here, details are provided of vouchers purchased, used and useful information such as expiry dates. If the user has misplaced a hard copy of the voucher, further copies can be generated. FIG. 4 also illustrates the tracking of vouchers purchased by a purchaser. As the register is in the form of a searchable database, this allows a search feature to be used allowing purchasers to search particular transactions according to different search criteria. Such search criteria can include, the date the voucher was purchased, the date the coupon was used, the voucher number, the expiry date of the voucher.

Tracking the total coupons and types of coupons further allows different coupons to be emailed or suggested to the purchaser.

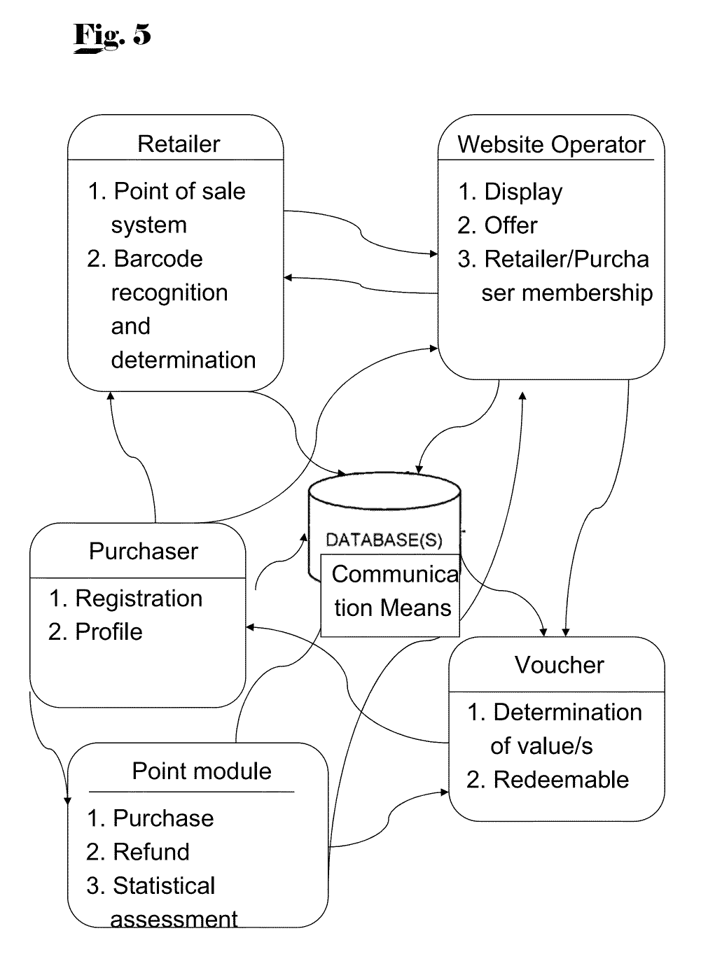

FIG. 5 provides a schematic image of the flow of communication between the different parties and elements of the embodiment.

In one form, FIG. 5 identifies the simultaneous line of communication that occurs between each user and each feature. The communication therefore operates in one embodiment as follows:

The retailer communicates information such as the product, actual value 34 and offeror's discount to the operator, including product details. The retailer and operator can then enter into negotiations to determine the final offeror's discount and the intended point value. Once determined, such information is then communicated by the operator to the purchaser.

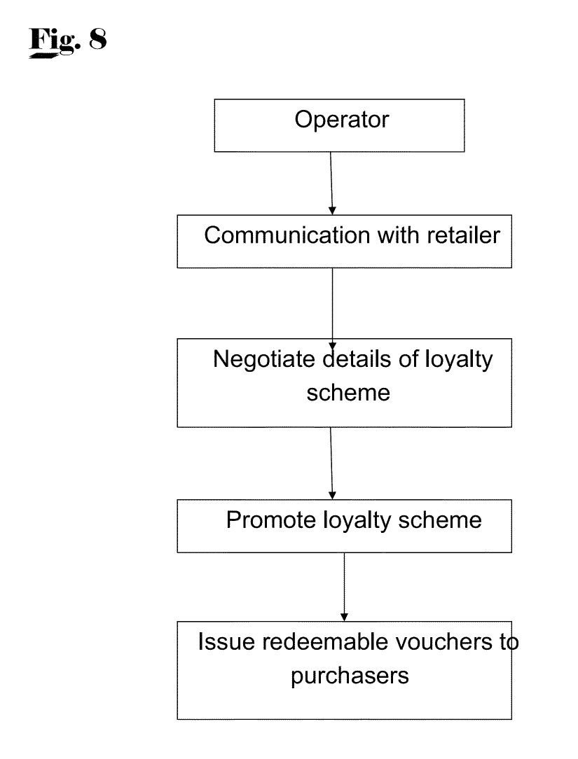

The website operator feeds information onto the product register, and communicates with the purchaser and the purchaser's profile page to update statistical data and registers on the purchasers profile page. The operator displays the display offers 22, provides membership to the retailer and purchaser, allows for display offers to be transferred to effective offers. The operator, in accordance with FIG. 8, further promotes the loyalty scheme and issues the effective vouchers to the purchaser.

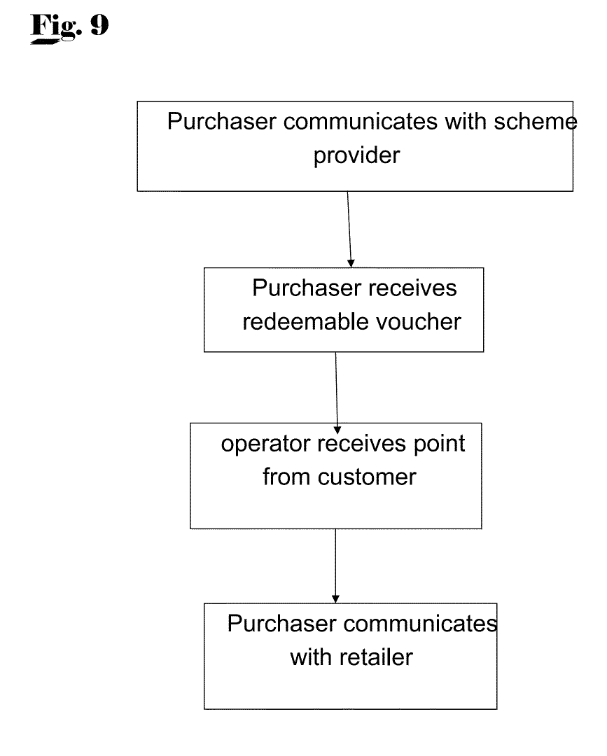

The purchaser, communicates with the operator in order to purchase refundable credits, and have access to displayed offers and then to convert the displayed offer to an effective offer 24B. The purchaser then communicates with the retailer directly when redeeming the voucher. The Purchaser's activities are recorded by the operator and updated onto their profile page and onto the webpage. The purchasers purchase of the effective offer 24B results in the update of the tracker 44 on the webpage. The communication by the purchaser is also summarised in FIG. 9.

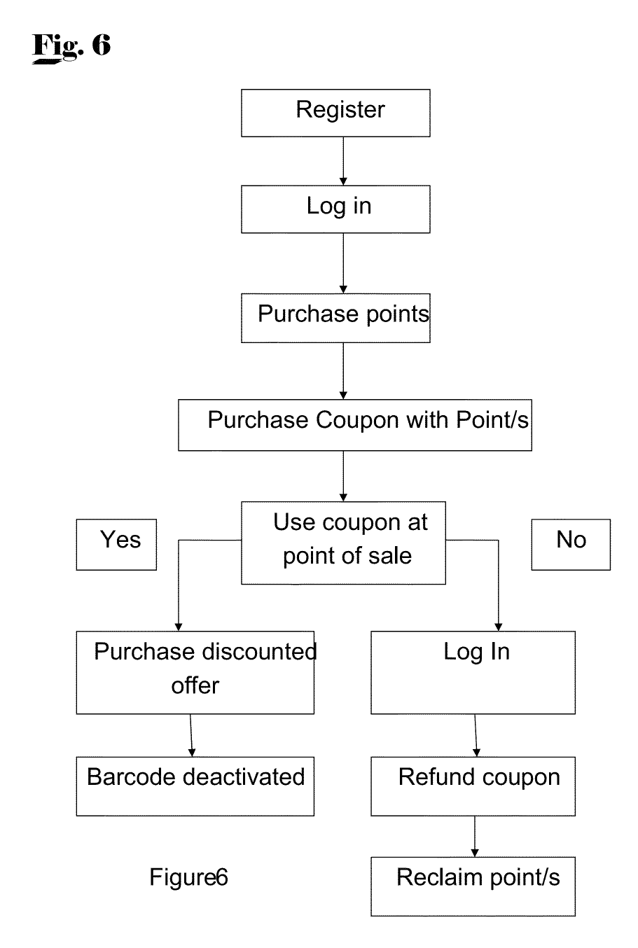

FIG. 6 provides a flow chard demonstrating use of the embodiment by a purchaser. The purchaser is to register onto the website and create their profile page. This includes personal details, contact details and any preferences to any services of products. This will assist in manipulating the type and nature of the offeror's products displayed to the purchaser.

The profile page also includes data that is automatically entered once the embodiment is used for example. The purchaser's credits are illustrated, to illustrate to the purchaser the number of credits available such that the purchaser can determine whether they have sufficient credits to match the point value of the displayed offers.

The purchaser is then able to use the vouchers by redeeming it directly with the retailer upon payment of the offer value 39.

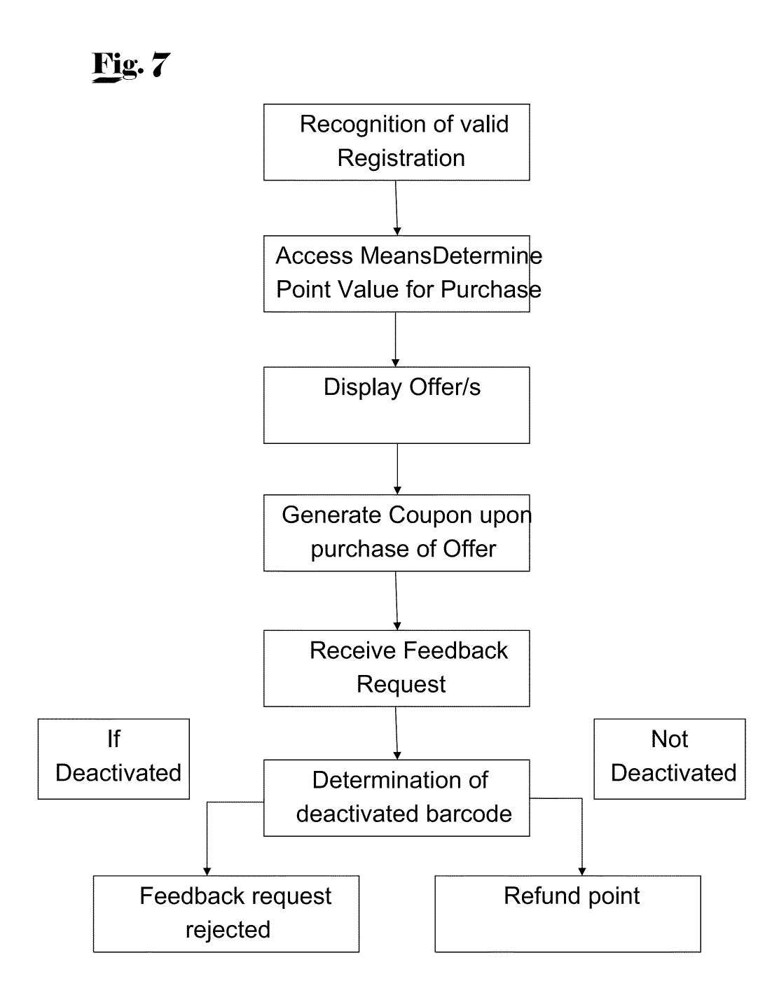

FIG. 7 provides the operational mechanism of the communication means during the steps of FIG. 6. For example, the access means determines whether the purchaser has sufficient number and value of credits that is required by the displayed offer to access the displayed offer and convert it to an effective offer.

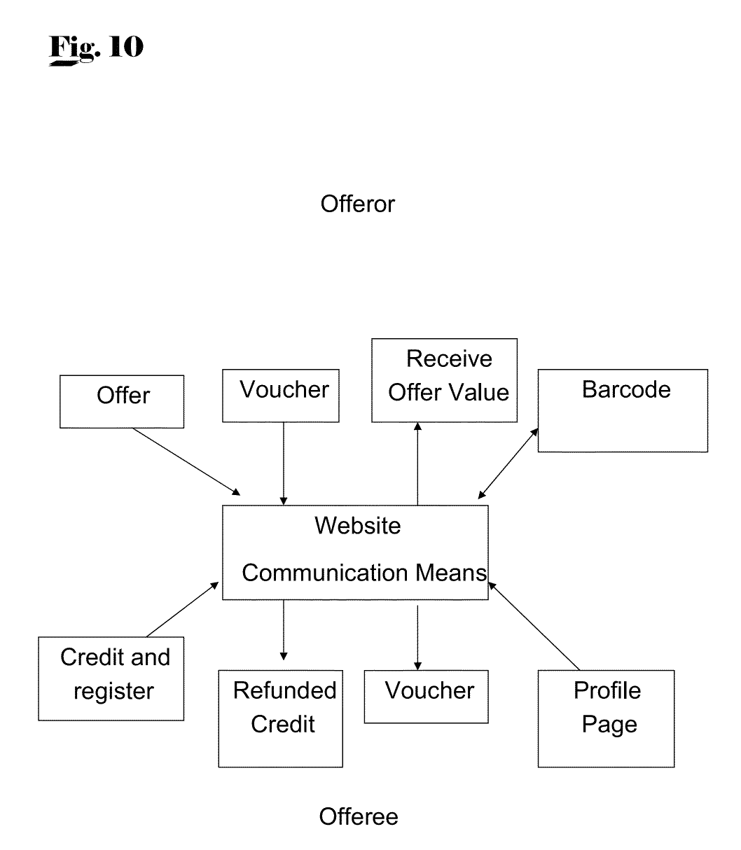

FIG. 10 illustrates the data that is inputted into the communication means by an offeror and outputted to the offeror by the communication means. In addition, FIG. 10 illustrates the data that is inputted into the communication means by an offeree or outputted to the offeree by the communication means.

In summary, the communication provides to the offeror the offer value 39. This is provided directly by the offeree to the offeror, either in person at the retailer's place of business or online. The offeror enters into the communication means details such as the offer, the product, the voucher (if it is according to an embodiment where it is pre-generated). Where the communication means provides a direct automatic feedback loop to the payment means, this provides a further output in the form of an active or deactivated voucher and input in the form of a signal from the payment means.

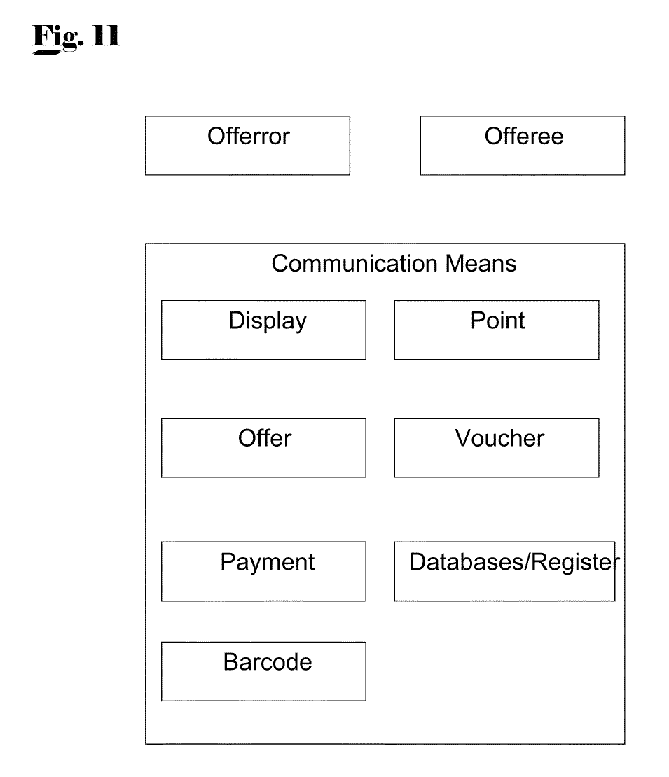

FIG. 11 provides a schematic of the components of the communication means.

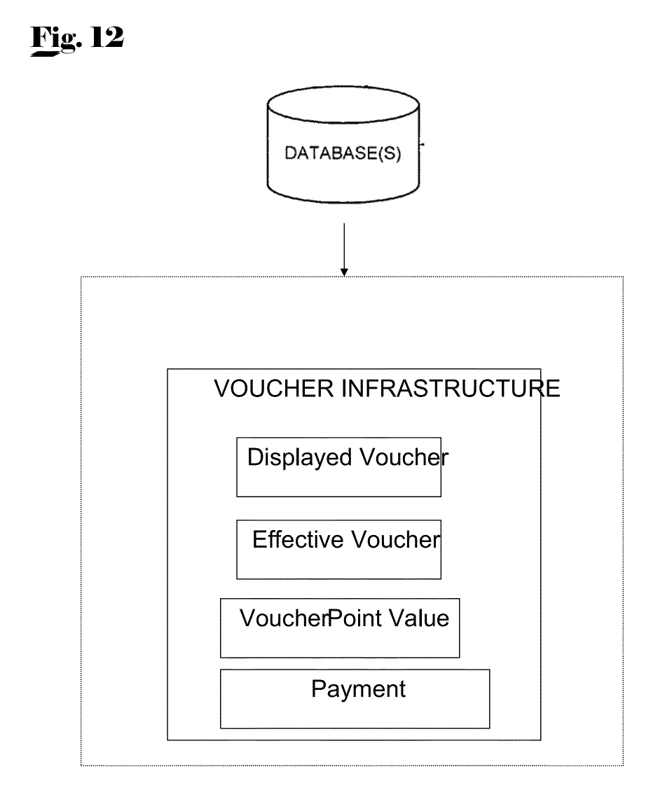

FIG. 12 provides a schematic of the infrastructure of the voucher. The infrastructure of the voucher is dependent on the status of the voucher. The voucher has a first status as a displayed offer, as seen in FIG. 1. The displayed offer is presented to a purchaser by a display means. If the purchaser is interested in the offeror's product and wants to proceed with the transaction, the second status is entered into, in the form of an effective offer. The effective offer is illustrated in FIG. 2 and has an active client identification number that is machine readable to render the effective offer deactivated upon an offeror's recognition of the identification number. The purchaser is able to access the effective offer only by the access means confirming that the purchase has available sufficient number and value of credits to the value of the point value of the displayed voucher. Therefore, the voucher is converted from the first status to the second status upon the recognition by the communication means and access means that the clients virtual point value credit register stores points of number and value equal to the number and value of points allocated to the displayed offer.

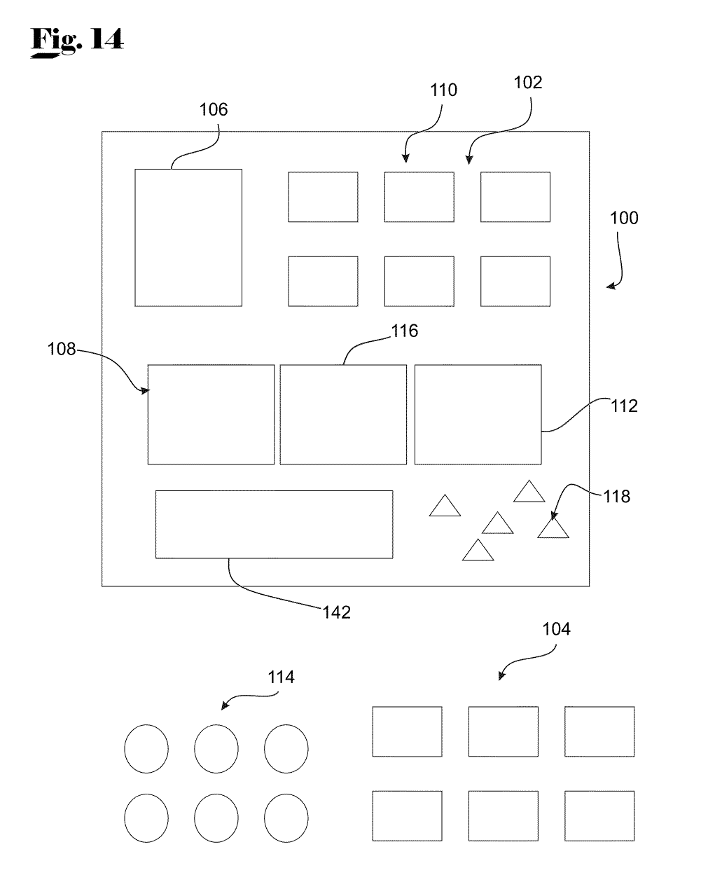

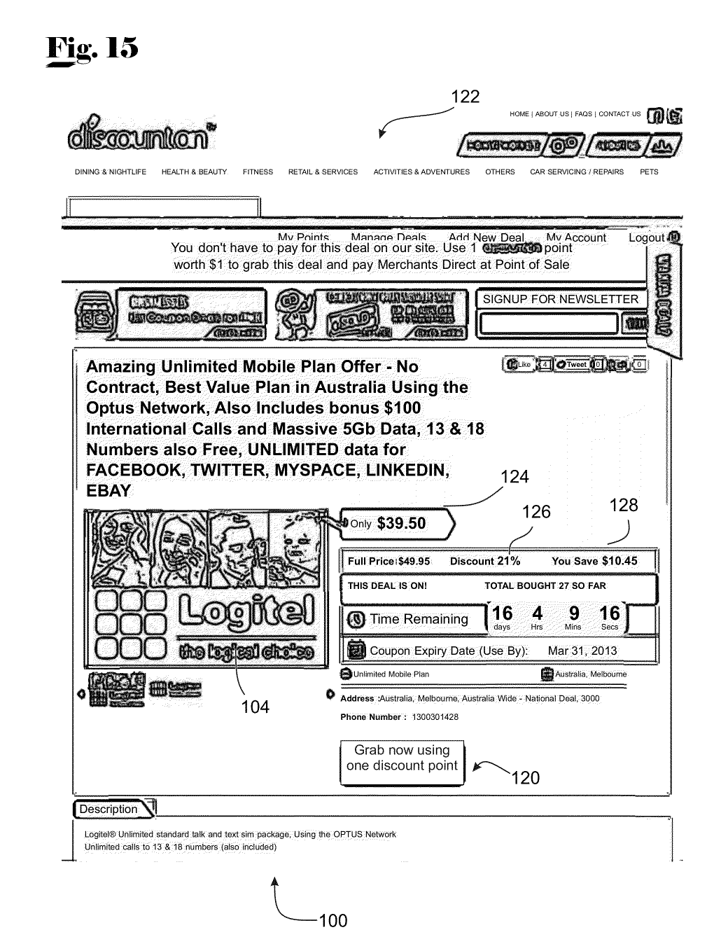

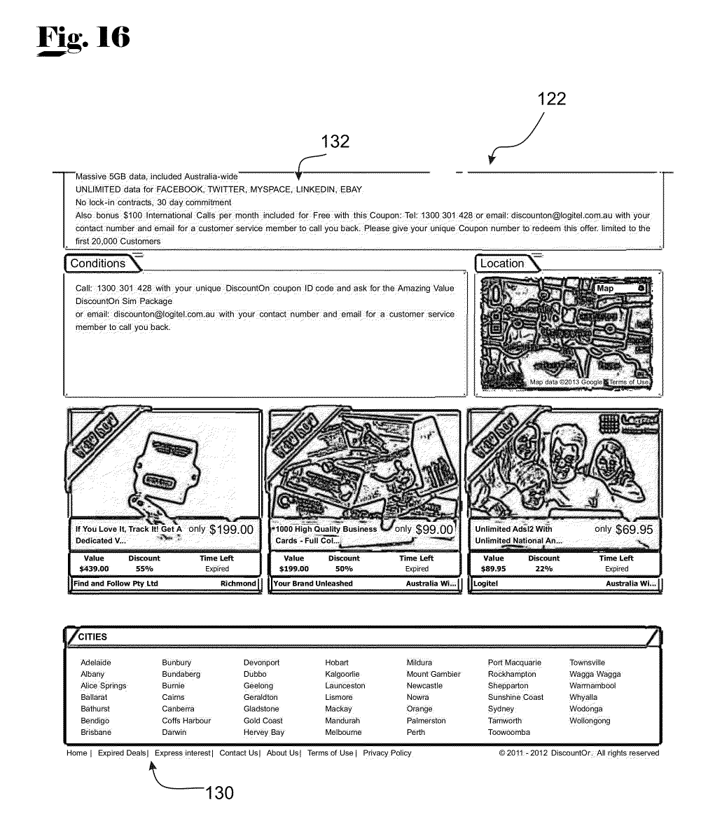

FIGS. 14 to 19 illustrate a computer implemented coupon system 100 according to a further preferred embodiment of the present invention. Referring to FIGS. 14 and 15 the computer implemented coupon system 100 is adapted to offer coupons 102 in connection with products and services 104. The system 100 includes a sale facility 106 for allowing individuals to purchase the coupons 102 online.

The coupons 102 each provide a reduction in price associated with a specific product or service 104. The system 100 includes a communications facility 108 for displaying, to the individuals, coupon information 110 associated with the coupons 102. The coupon information 110 includes a description and terms.

Advantageously the system 100 includes a coupon tracker 112 that is adapted to provide coupon providers 114 with a clear indication of the number of individuals who have purchased coupons and, as a result, are likely to intend to use the coupons.

By requiring that individuals purchase the coupons 102 it is considered that there is an increased likelihood of the individuals redeeming the coupons. This is considered to provide an advantage in that the coupon providers 114 are provided with a relatively accurate indication of the likelihood of coupon redemption and the sale of the products or services 104.

The system 100 includes a points facility 116 that is adapted to allow the individuals to purchase points 118. The sale facility 106 allows individuals to purchase the coupons 102 using the points 118 purchased using the points facility 116. The points 118 act as a virtual currency.

In the embodiment the majority of the coupons 102 are displayed for sale at a single unit 120 of the points 118 (i.e. one point). This is shown in an interface 122 of the system 100 in FIG. 15. The interface 122 shows an effective purchase price 124, a discount percentage 126 and a saving 128. The interface 122 also advantageously provides the ability to set a location 130. Various details and conditions 132 of the coupon validity are displayed in the interface 122.

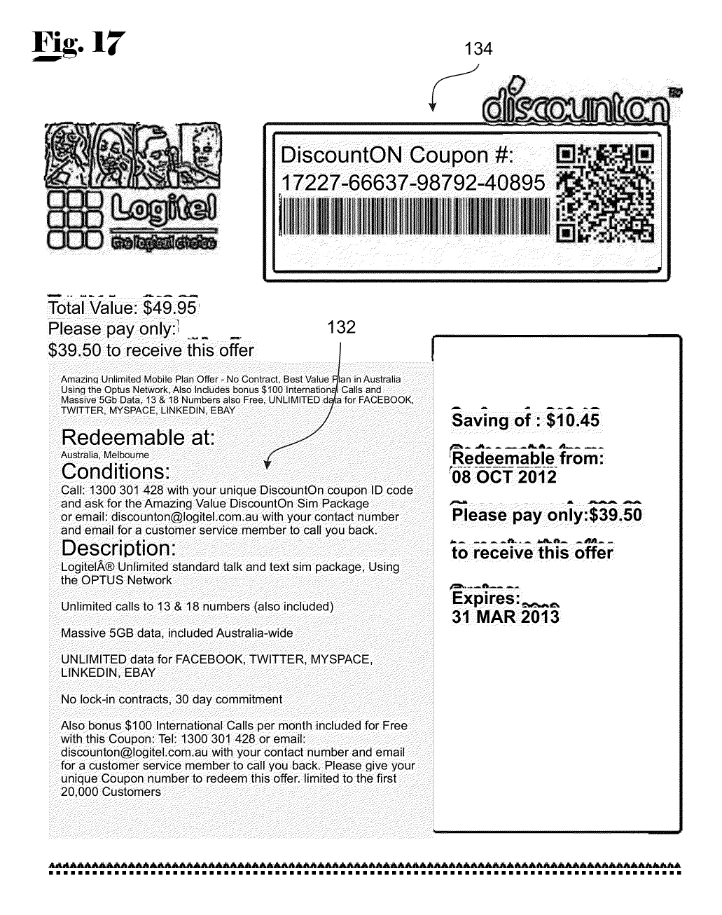

Referring to FIG. 17, after purchasing a coupon 102 the individual is provided with a unique coupon identifier 134. The identifier 134 is represented by both a bar code and a QR code. The various details and condition 132 are detailed in the document detailing the unique coupon identifier 134.

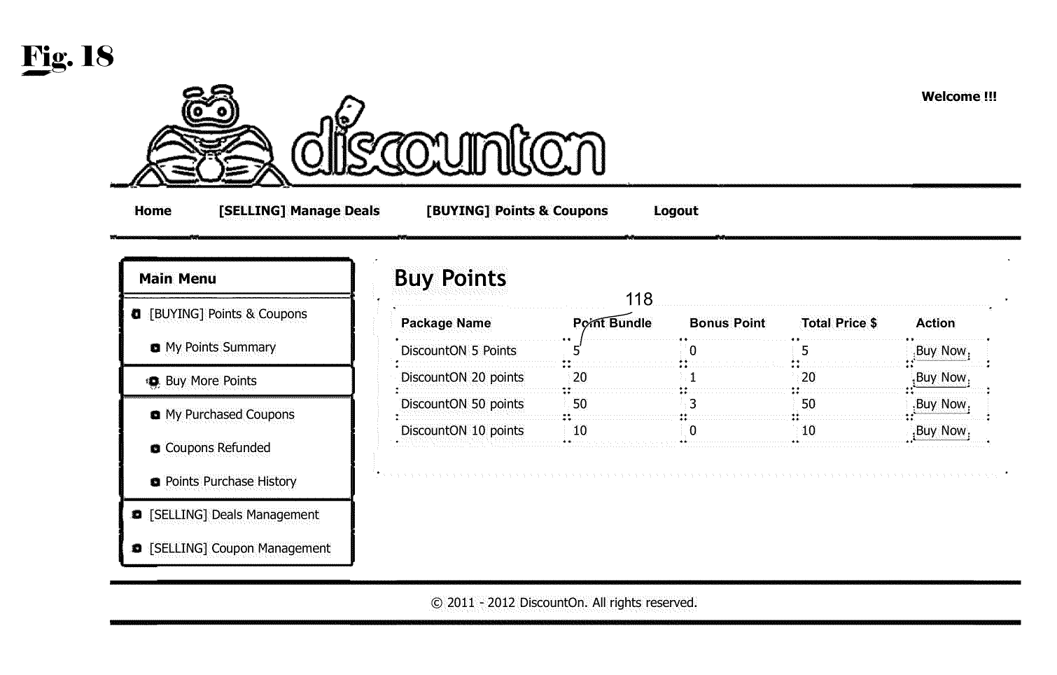

Referring to FIG. 18 a single point 118, excluding any bulk discounts, equates to the most convenient unit of real currency of a jurisdiction determined by the system. In this case the jurisdiction is Australia and the purchase of a single point equates to a purchase price of one Australian dollar.

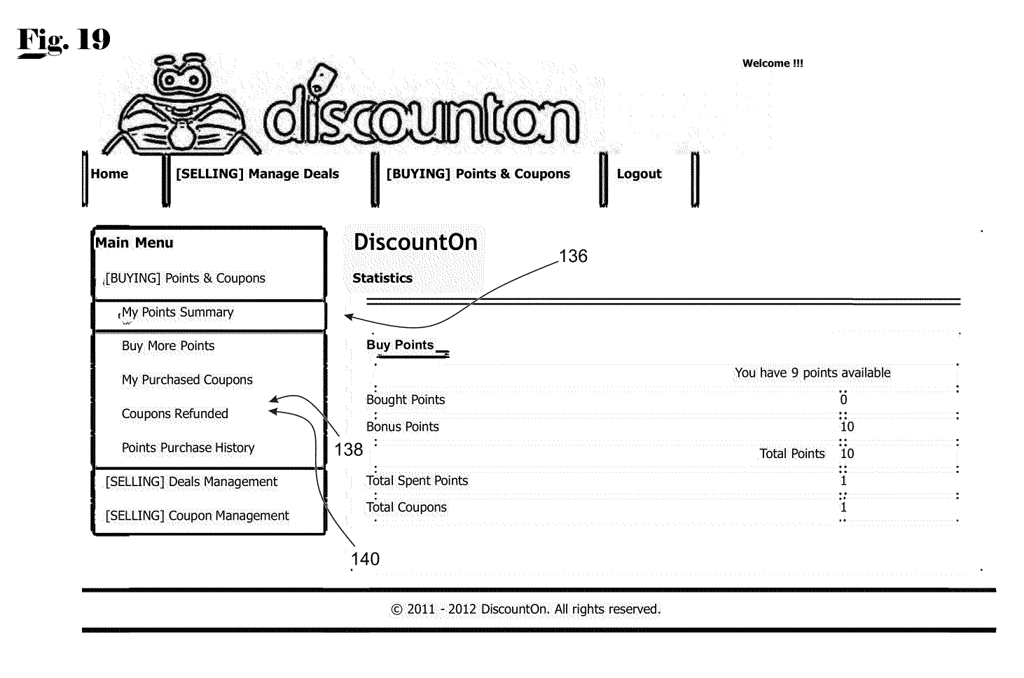

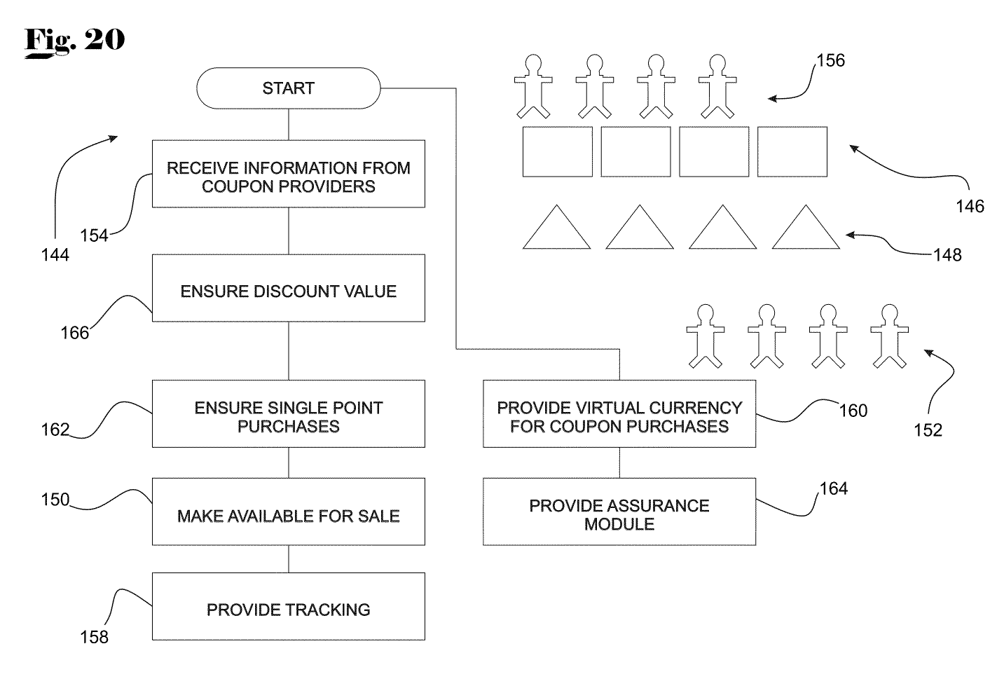

Referring to FIGS. 19 and 20 each individual is provided with a point tally 136. An assurance facility 138 is provided in the form of a refund module 140 The refund module provides a form allowing a user to enter a coupon id and enter relevant details as to the refund policy that should be applied. For example the refund module preferably provides options for specifying details such as: 1) the coupon not being honoured; and 2) the goods or services associated with a coupon not being received by the individual, after the coupon has been redeemed.

Returning to FIG. 14, the system 100 includes a determination facility 142 for automatically generating coupon data based on a regular retail price and an effective discounted price. The determination facility 142 ensures that the effective discounted price provides an effective discount greater than a single point value (i.e. the purchase value of the coupon). In other embodiments the coupon provider enters a discount and the determinator subtracts the point value which in this embodiment is automatically set to a single point.

The determination facility 142 is accordingly preconfigured to automatically generate the coupon data based on a coupon purchase price of a single point.

Referring to FIG. 20 there is shown a computer implemented method 144 according to a further preferred embodiment of the present invention. The method 144 provides coupons 146 for products and services 148. At block 150, the method 144 comprises allowing individuals 152 to purchase the coupons 146 online, the coupons 146 each providing a reduction in price associated with a specific product or service 148.

At block 154 the method 144 includes allowing coupon providers 156, to provide information for advertisements associated with the coupons. At block 158 the method 144 provides tracking to provide the coupon providers 156 with a clear indication of the number of individuals 152 who have purchased coupons 146. It is considered that, by virtue of purchasing the coupons, the coupon providers 156 are provided with an advantageously accurate indication of the number of users likely to redeem the coupons 146.

At block 160 the method 144 includes provides a virtual point currency allowing the individuals 152 to purchase the coupons 146. This includes providing a points facility adapted to allow the individuals 152 to purchase points, to allow the individuals 152 to purchase the coupons online using the points.

At block 162 the method 144 ensures that coupons 146 are purchased for a single currency point. At block 160 each currency point is sold for a dollar of real currency. At block 164 a refund is provided to an individual when coupon is not honoured. A refund is also provided when the product or service is not received by the individual, after the associated coupon has been redeemed. The provision of a refund is considered to be advantageous.

At block 166 the method 144 includes ensuring that the value of the coupon to the individual, when redeeming the coupon, is more than the value of the sale price of the coupon. This is achieved by subtracting the value of the coupon from a discount value to provide an effective discount.

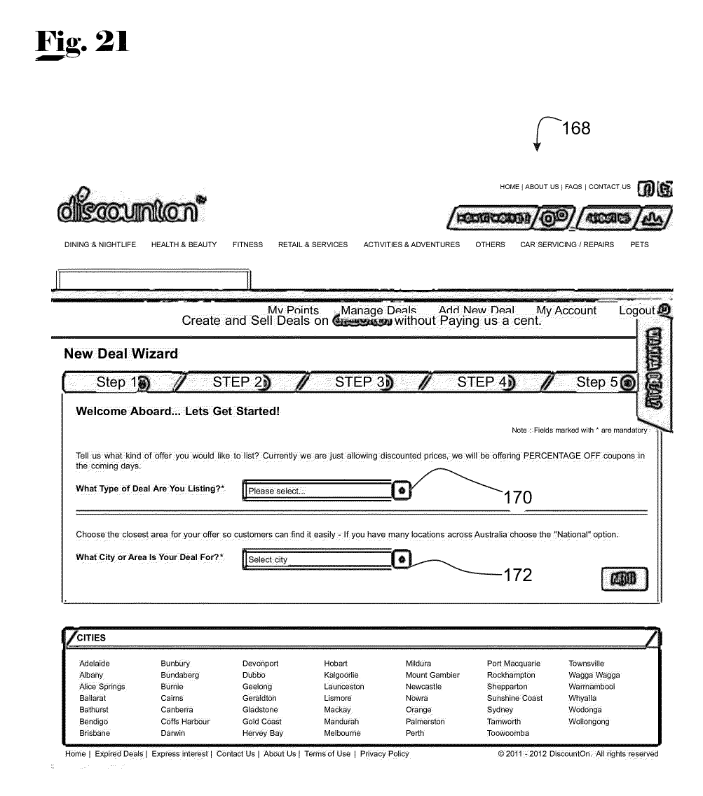

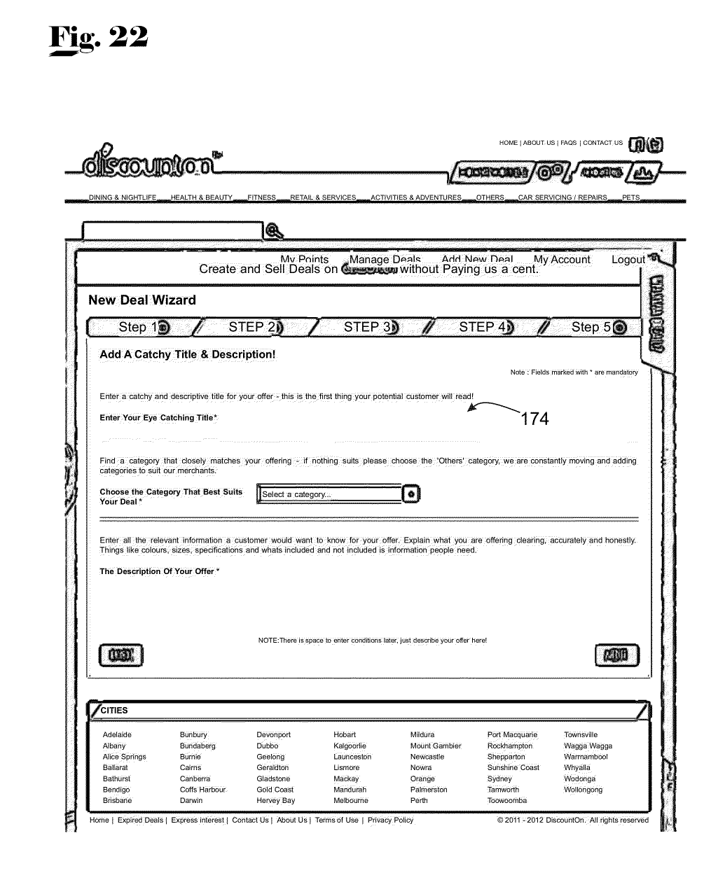

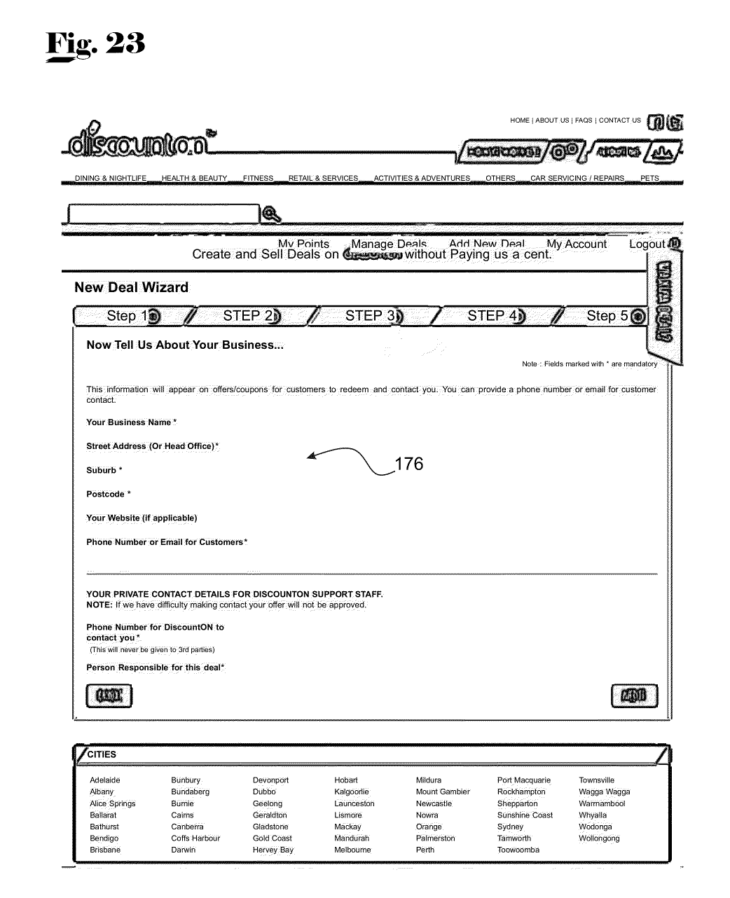

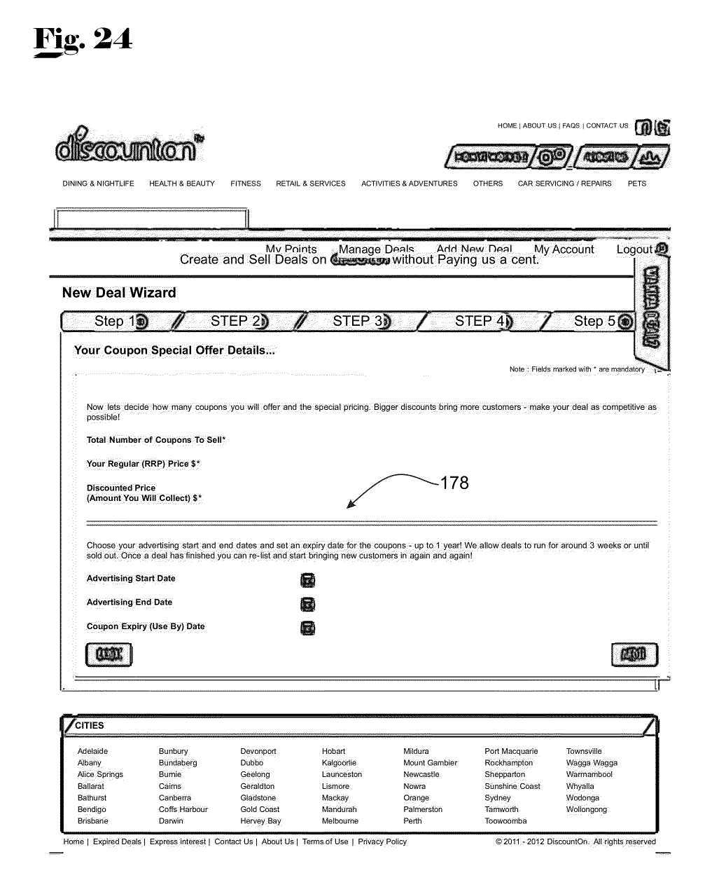

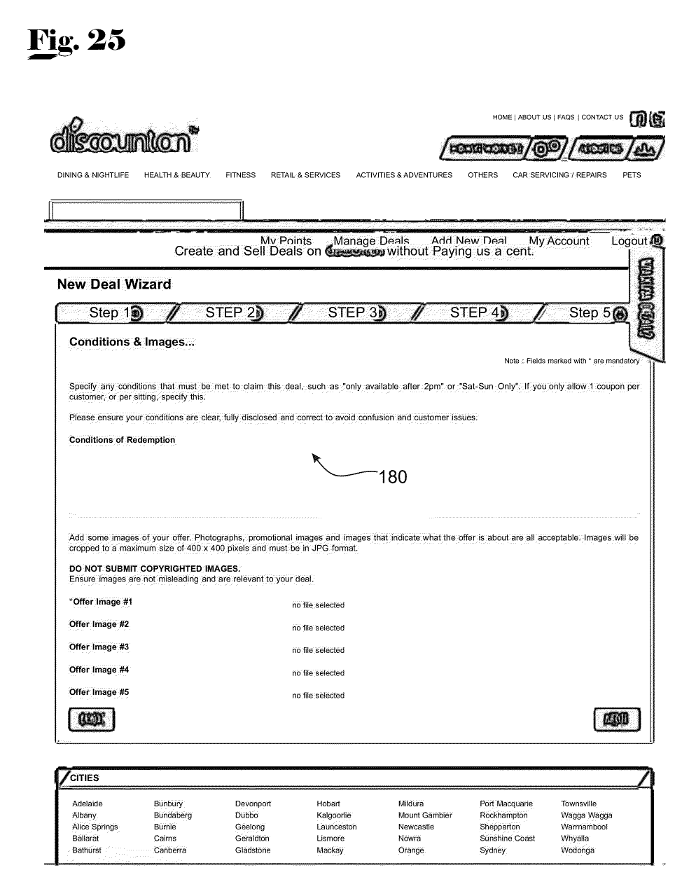

Referring to FIGS. 21 to 25 there is shown a method 168 according to a further embodiment of the present invention. At block 170 the coupon provider enters the type of deal in terms of a dollar discount or a percentage. At block 172 the coupon provider specifies a location associated with the coupon. A list of location is provided based on the country associated with the individual. At block 174 the provider specifies a title, categorizes the coupon and enters a description. At block 176 contact information is provided.

At block 178 the number of coupons, a regular price and a discount price are specified. The system ensures that the regular price and discount price are separated by more than the currency value of one point. At block 180 conditions are specified and images associated with the coupon are uploaded.

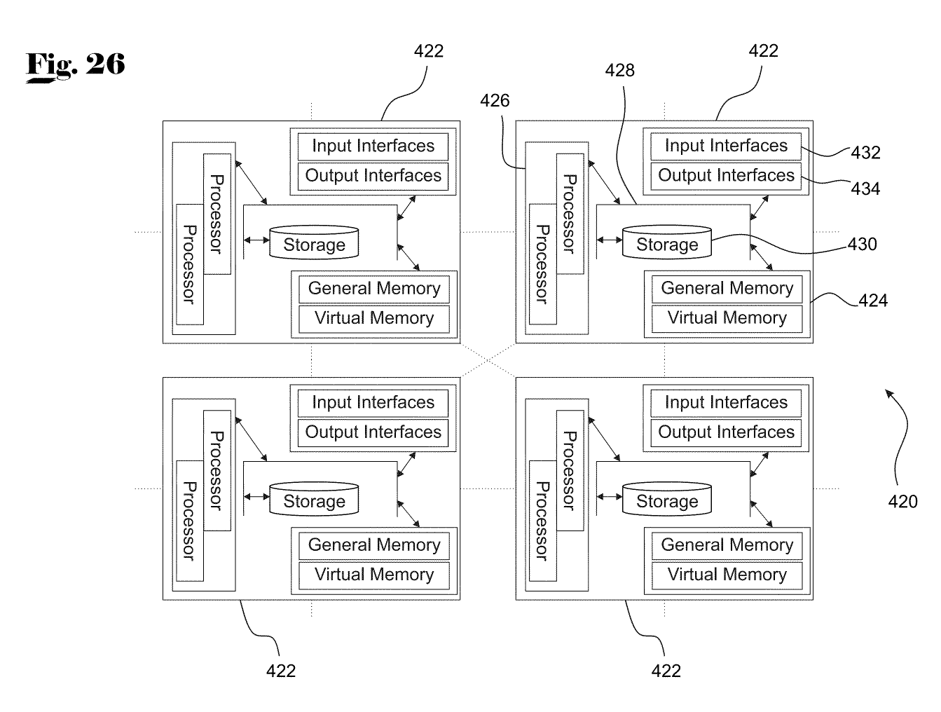

Referring to FIG. 26 there is shown a schematic diagram of a computer system 420 that is configured to provide preferred arrangements of systems and methods described herein. The computer system 420 is provided as a distributed computer environment containing a number of individual computer systems 422 (computers/computing devices) that cooperate to provide the preferred arrangements. In other embodiments the computer system 420 is provided as a single computing device.

As shown, a first one of the computing devices 422 includes a memory facility 424. The memory facility 424 includes both ‘general memory’ and other forms of memory such as virtual memory. The memory facility 424 is operatively connected to a processing facility 426 including at least one processor. The memory facility 424 includes computer information in the form of executable instructions and/or computer data. The memory facility 424 is accessible by the processing facility 426 in implementing the preferred arrangements.

As shown each of the computing devices 422 includes a system bus facility 428, a data store facility 430, an input interface facility 432 and an output interface facility 434. The data store facility 430 includes computer information in form of executable instructions and/or computer data. The data store facility 430 is operatively connected to the processing facility 426. The data store facility 430 is operatively connected to the memory facility 424. The data store facility 430 is accessible by the processing facility 426 in implementing the preferred arrangements.

Computer information may be located across a number of devices and be provided in a number of forms. For example the data store facility 430 may include computer information in the form of executable instructions and/or computer data. The computer data information may be provided in the form of encoded data instructions, data signals, data structures, program logic for server side operation, program logic for client side operation, stored webpages and so forth that are accessible by the processing facility 426.

On one level, input interfaces allow computer data to be received by the computing devices 422. On another level, input interfaces allow computer data to be received from individuals operating one or more computer devices. Output interfaces, on one level, allow for instructions to be sent to computing devices. On another level, output interfaces allow computer data to be sent to individuals. The input and output interface facilities 432, 434 provide input and output interfaces that are operatively associated with the processing facility 426. The input and output facilities 432, 434 allow for communication between the computing devices 422 and individuals.

The computing devices 422 provide a distributed system in which several devices are in communication over network and other interfaces to collectively provide the preferred arrangements. Preferably there is provided at least one client device in the system of computing devices 422 where the system is interconnected by a data network.

The client device may be provided with a client side software product for use in the system which, when used, provides systems and methods where the client device and other computer devices 422 communicate over a public data network. Preferably the software product contains computer information in the form of executable instructions and/or computer data for providing the preferred arrangements.

Input interfaces associated with keyboards, mice, trackballs, touchpad's, scanners, video cards, audio cards, network cards and the like are known. Output interfaces associated with monitors, printers, speakers, facsimiles, projectors and the like are known. Network interfaces in the form of wired or wireless interfaces for various forms of LANs, WANs and so forth are known. Storage facilities in the form of floppy disks, hard disks, disk cartridges, CD-ROMS, smart card, RAID systems are known. Volatile and non-volatile memory types including RAM, ROM, EEPROM and other data storage types are known. Various transmission facilities such as circuit board material, coaxial cable, fibre optics, wireless facilities and so forth are known. It is to be appreciated that systems, components, facilities, interfaces and so forth can be provided in several forms. Systems, components, facilities, interfaces and so forth may be provided as hardware, software or a combination thereof. The present invention may be embodied as computer readable memory, a personal computer and distributed computing environments.

In addition the present invention may be embodied as: a number of computer executable operations; a number of computer executable components; a set of process operations; a set of systems, facilities or components; a computer readable medium having stored thereon computer executable instructions for performing computer implemented methods and/or providing computer implemented systems; and so forth. In the case of computer executable instructions they preferably encode the systems, components and facilities described herein. For example a computer-readable medium may be encoded with one or more facilities configured to run an application configured to carry out a number of operations forming at least part of the present arrangements. Computer readable mediums preferably participate in the provision of computer executable instructions to one or more processors of one or more computing devices.

Computer executable instructions are preferably executed by one or more computing devices to cause the one or more computing devices to operate as desired. Preferred data structures are preferably stored on a computer readable medium. The computer executable instructions may form part of an operating system of a computer device for performing at least part of the preferred arrangements. One or more computing devices may preferably implement the preferred arrangements.

The term computer is to be understood as including all forms of computing device including servers, personal computers, smart phones, digital assistants and distributed computing systems.

Computer readable mediums and so forth of the type envisaged are preferably intransient. Such computer readable mediums may be operatively associated with computer based transmission facilities for the transfer of computer data. Computer readable mediums may provide data signals. Computer readable mediums preferably include magnetic disks, optical disks and other electric/magnetic and physical storage mediums as may have or find application in the industry. Components, systems and tasks may comprise a process involving the provision of executable instructions to perform a process or the execution of executable instructions within say a processor. Applications or other executable instructions may perform method operations in different orders to achieve similar results. It is to be appreciated that the blocks of systems and methods described may be embodied in any suitable arrangement and in any suited order of operation. Computing facilities, modules, interfaces and the like may be provided in distinct, separate, joined, nested or other forms arrangement. Methods will be apparent from systems described herein and systems will be apparent from methods described herein.

Throughout this specification and the claims which follow, unless the context requires otherwise, the word “comprise”, and variations such as “comprises” and “comprising”, will be understood to imply the inclusion of a stated integer or group of integers or steps but not the exclusion of any other integer or group of integers or steps.

Those skilled in the art will appreciate that the invention described herein is susceptible to variations and modifications other than those specifically described and such changes are intended to be included within the scope of the appended claims. It is to be understood that the invention includes all such variations and modifications. The invention also includes all of the steps, features, compositions and compounds referred to or indicated in this specification, individually or collectively, and any and all combinations of any two or more of said steps or features.

1. A computer implemented coupon system for offering coupons in connection with products and services comprising: a sale facility adapted to allow individuals to purchase coupons online, the coupons each providing a reduction in price associated with a specific product or service; and a communications facility for displaying, to the individuals, coupon information associated with the coupons.

2. A computer implemented coupon system as claimed in claim 1 wherein the communications facility includes a coupon tracker; the coupon tracker being adapted to provide coupon providers with a clear indication of the number of individuals who have purchased coupons and, as a result of the purchases, are likely to intend to use them.

3. A computer implemented coupon system as claimed in claim 1 wherein the system includes a points facility adapted to allow the individuals to purchase points, the sale facility being adapted to allow the individuals to purchase the coupons using the points.

4. A computer implemented coupon system as claimed in claim 3 wherein the majority of the coupons are able to be purchased for a single point.

5. A computer implemented coupon system as claimed in claim 4 wherein a single unit of the points, excluding any bulk discounts, equates to the most convenient unit of real currency of a jurisdiction determined by the system.

6. A computer implemented coupon system as claimed in claim 5 wherein the most convenient unit of real currency is one Australian dollar when the determined jurisdiction is Australia.

7. A computer implemented coupon system as claimed in claim 5 wherein the most convenient unit of real currency is one US dollar when the determined jurisdiction is the United States of America.

8. A computer implemented coupon system as claimed in claim 1 including an assurance facility adapted to provide an individual with a refund when a coupon is not honoured and adapted to provide an individual with refund when the products or services associated with a coupon are not received by the individual, after the coupon has been redeemed.

9. A computer implemented coupon system as claimed in claim 1 including a determination facility for automatically generating coupon data based on a regular retail price and an effective discounted price.

10. A computer implemented method of providing coupons for products and services comprising: providing coupons online for purchase by individuals, the coupons each providing a reduction in price associated with a specific product or service; and displaying, to the individuals, coupon information associated with the coupons.

11. A computer implemented method as claimed in claim 10 including, providing a tracking facility adapted to provide coupon providers with a clear indication of the number of individuals who have purchased the coupons and, as a result of the purchases, are likely to be intending to use them.

12. A computer implemented method as claimed in claim 10 including providing a points facility adapted to allow the individuals to purchase points, so as to allow the individuals to purchase the coupons online using the points.

13. A computer implemented method as claimed in claim 12 including ensuring that the majority of the coupons are able to be purchased for a single point.

14. A computer implemented method as claimed in claim 13 wherein a single point, excluding any bulk discounts, equates to the most convenient unit of real currency of a jurisdiction determined by the system.

15. A computer implemented method as claimed in claim 14 wherein the most convenient unit or real currency is one US dollar when the determined jurisdiction is the United States.

16. A computer implemented method as claimed in claim 1 including providing a refund facility and ensuring that: 1) individuals are provided with a refund when a coupon is not honoured and 2) individuals are provided with a refund when the products or services associated with a coupon are not received by the individual, after the coupon has been redeemed.

17. A computer implemented method as claimed in claim 14 including ensuring that the value of the coupon to the individual, when redeeming the coupon, is more than the value of the sale price of the coupon.

18. A computer implemented method as claimed in claim 14 including preconfiguring the method to automatically generate the coupon data based on a coupon purchase price of a single unit of points.

19. A non-transient computer readable medium having stored thereon computer executable instructions for performing a computer implemented system as claimed claim 1.

20. A non-transient computer readable medium having stored thereon computer executable instructions encoding a computer implemented method as claimed in claim 14.
